(19) United States
(12) Patent Application Publication
(10) Pub. No.: US 2009/0129843 A1
(43) Pub. Date: May 21, 2009

(54) Print Head for Braille Printer

(76) Inventor: David Pillischer, River Vale, NJ (US)

Correspondence Address: SEAN LIAM KELLEHER;Kelleher IP PLLC, 16 PECKSLIP RD, CARMEL, NY, 10512, US

(21) Appl. No.: 11/940,323

(22) Filed: Nov. 15, 2007

(51) Int. Cl. B41J 3/32

(52) U.S. Cl. 400/109.1

(57) ABSTRACT

A device for embossing Braille characters on an embossable substrate includes a print head and an anvil. The head containing a series of raised locations. The raised locations contain a combination of pins and are configured to print one or more columns of a Braille cell. The anvil is configured with a series of depressions for mating with the pins of the print head. Embossing occurs when the anvil or print head is moved against the other and the embossable substrate is made to conform to the depressions in the locations where a pin on the print head is positioned.

### BACKGROUND OF THE INVENTION

1. Field of the Invention

The invention relates to a print head having a combination of pins for a Braille printing machine. More particularly, the printer head of the present invention is especially useful in a printing machine interfaced with a printer which is provided with the appropriate software for formulating pages of Braille text from an input.

2. Description of the Related Art

Various types of high speed printers have been devised for generating a so-called hard copy or paper output from various data and word processing machines, e.g., high speed digital computers. Among these various types is one class of printing mechanism often referred to as a dot matrix printer. Typically, in these devices, a print head carrying a plurality of impact pins is traversed across the paper and the pins are actuated in an organized sequence to create recognizable print characters. This has been useful for ink printing where the impact force required to transfer the ink from the ribbon to the paper is relatively low. However, in other types of printing, particularly embossing or raised letter printing the impact force is many times greater. One such type of raised letter printing is Braille.

The Braille system, devised in 1821 by Frenchman Louis Braille, is a method that is widely used by blind people to read and write. Each Braille character or cell is made up of six dot positions, arranged in a rectangle containing two columns of three dots each. A dot may be raised at any of the six positions to form sixty-four (2⁶) combinations, including the combination in which no dots are raised. For reference purposes, a particular combination may be described by naming the positions where dots are raised, the positions being universally numbered 1 to 3, from top to bottom, on the left, and 4 to 6, from top to bottom, on the right. For example, dots 1-3-4 would describe a cell with three dots raised, at the top and bottom in the left column and on top of the right column, i.e., the letter m. see FIG. 1a.

Braille has also been extended to an 8-dot code, see FIG. 1b, particularly for use with Braille embossers and refreshable Braille displays. In 8-dot Braille the additional dots are added at the bottom of the cell, giving a matrix 4 dots high by 2 dots wide. The additional dots are given the numbers 7 (for the lower-left dot) and 8 (for the lower-right dot). 8-dot Braille has the advantages that the case of an individual letter is directly coded in the cell containing the letter and that all the printable ASCII characters can be represented in a single cell. All 256 (2⁸) possible combinations of 8 dots are encoded by the Unicode standard.

In Braille, pages are separated by a line so that you can feel going across the page. Braille characters are much larger than their printed equivalents, and the standard 11″ by 11.5″ (28 cm×30 cm) page has room for only 25 lines of 43 characters. To reduce space and increase reading speed, virtually all Braille books are transcribed in what is known as Grade 2 Braille, which uses a system of contractions to reduce space and speed the process of reading. As with most human linguistic activities, Grade 2 Braille embodies a complex system of customs, styles, and practices.

Dot height is approximately 0.02 inches (0.5 mm); the horizontal and vertical spacing between dot centers within a Braille cell is approximately 0.1 inches (2.5 mm); the blank space between dots on adjacent cells is approximately 0.15 inches (3.75 mm) horizontally and 0.2 inches (5.0 mm) vertically. A standard Braille page is 11 inches by 11.5 inches and typically has a maximum of 40 to 43 Braille cells per line and 25 lines.

Braille may be printed using a zinc printing plate in which character dot impressions are produced. A typesetting machine is then used to produce a printing plate from the zinc printing plate. The printing plate is then pressed onto the surface of the recording medium, e.g., paper, to produce the printed Braille material. This is useful where multiple copies of a particular work are desired. However, it is impractical for single copies of written material, such as personal letters. More recently, special Braille writers have been developed such as Braille typewriters and the like to write Braille.

In Braille typewriters, Braille is printed on a recording medium, such as paper, using a hard Braille plate employed as a working die and a printing rod having a pin-shaped projection employed as an embossing die. Other, more conventional, but nonetheless electronic Braille printers are also known. For instance, in U.S. Pat. No. 4,488,828, Ohtsuki utilizes solenoids to print Braille characters one at a time, typewriter-style. This utilizes a single solenoid permitting a simpler design; however, it is very time consuming to print a full line or page of Braille, as a character can contain as many as six raised dots.

It is known, in general, to provide a computer driven Braille printing machine. There are, in fact, several such printers in the market today. For instance, in U.S. Pat. No. 3,380,269 issued Apr. 29, 1975 to Carboneau, a Braille printer is disclosed in which, lines of Braille dots are printed (i.e. embossed for touch reading) simultaneously (three consecutive such lines of dots comprising a line of Braille characters) as paper is drawn lengthwise through a printer (usual typewriter fashion). The dots are printed by a line of Braille printing pins. There is one printing pin for each potential dot across the paper. Each pin travels in a guide path bored in a frame and is actuated by a lever which is powered by a solenoid. Actuation of the solenoid pulls its associated lever downwardly, causing the opposite end of the lever to power the pin upwardly into the substrate paper. Such a printing head essentially divides up a page into as many vertical columns as it has printing pins, and prints a page in a corresponding fraction of the time it would take a machine with a printing head having only one pin. This is certainly a functional arrangement for a printer, but it requires a solenoid-lever-pin combination for each dot in a line of Braille dots. Moreover, this device requires a large rigid frame on which the many solenoid-lever-pin combinations can be mounted.

The trend in high-speed printing has been, as noted above in relation to Carboneau, to abandon the concept of a moving head, in favor of a system providing a single Braille printing pin for each vertical row of Braille dots on a page. However, the large rigid frame and multitude of solenoids is cost prohibitive for individual consumers. Further, each solenoid must be maintained adding further cost.

### SUMMARY OF THE INVENTION

The present invention relates to a printer head having a combination of pins for a Braille printing machine. More particularly, the printer head of the present invention is especially useful in a printing machine interfaced with a computer which is provided with the appropriate software for formulating pages of Braille text from an input of sight readable alphanumeric data.

It is an object of the present invention to provide for a novel printer head for use on a typewriter or printer which will print a Braille character. The printer head contains a generally round head and an anvil. Paper is inserted in to the print head and travels between the head and the anvil. The head contains various combinations of pins about its circumference. The combinations of pins are aligned in vertical positions of one column of a Braille character. The head is rotated such that a combination of pins is brought in alignment with the anvil. Thus when the anvil is moved forward toward the head, the paper enters recesses in the anvil in the location of the particular raised pins. This causes an embossed dot or dots to be created on a sheet of paper at a predetermined location. By indexing the print head and the anvil to the next column the Braille, and repeating, character is completed. The forward movement of the anvil on the pins is limited by small depressions located on the anvil on the other side of an inserted sheet of paper on which the Braille impressions are to be embossed. The printer head of the present invention can be traversed across the paper to complete a line of Braille text.

### BRIEF DESCRIPTION OF THE SEVERAL VIEWS OF THE DRAWINGS

FIG. 1 is a diagram of a six dot Braille cell indicating the six dot locations;

FIG. 1a is a diagram of the letter “m” in Braille;

FIG. 1b is a diagram of an eight dot Braille cell indicating the locations of dot 7 and 8;

FIG. 2 is a perspective view of the round head according to an aspect of the present invention;

FIG. 3 is top view of the round head of FIG. 2;

FIG. 4 is an exploded view of the circumference of the round head of FIG. 2 showing the pin combinations;

FIG. 5 is a view of one of the pins of the print head of FIG. 2;

FIG. 6 is a front view of the anvil according to one aspect of the present invention;

FIG. 7 is a cut away view along line A-A of FIG. 6;

FIG. 8 is an exploded view of a print head with a four pin configuration according to an aspect of the invention.

### DETAILED DESCRIPTION OF THE INVENTION

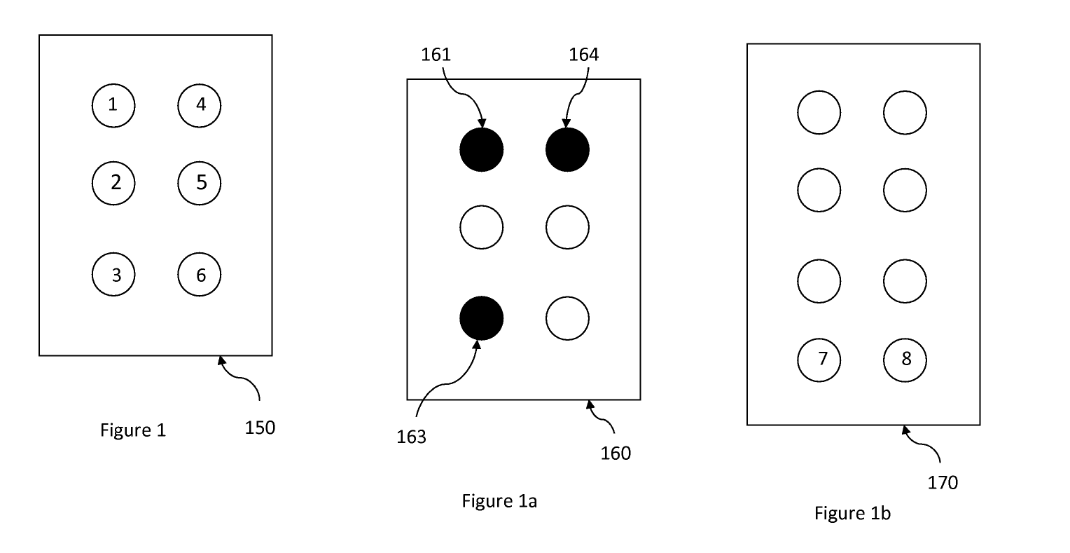

FIG. 1 shows the standard Braille cell 150. Each Braille character or cell 150 is made up of six dot positions, arranged in a rectangle containing two columns of three dots each. A dot may be raised at any of the six positions to form sixty-four (2⁶) combinations, including the combination in which no dots are raised. For reference purposes, a particular combination may be described by naming the positions where dots are raised, the positions being universally numbered 1, 2 and 3, from top to bottom, on the left, and 4, 5 and 6, from top to bottom, on the right. For example, in FIG. 1a the cell 160 has raised dots 161-163-164 and would describe a cell with three dots raised, at the top and bottom in the left column and on top of the right column, i.e., the letter m.

An expanded Braille cell 170 is shown in FIG. 1b. The expanded cell 170 has eight dot locations. The additional locations are added to the bottom of the original two columns and are universally numbered 7 on the bottom left and 8 on the bottom right.

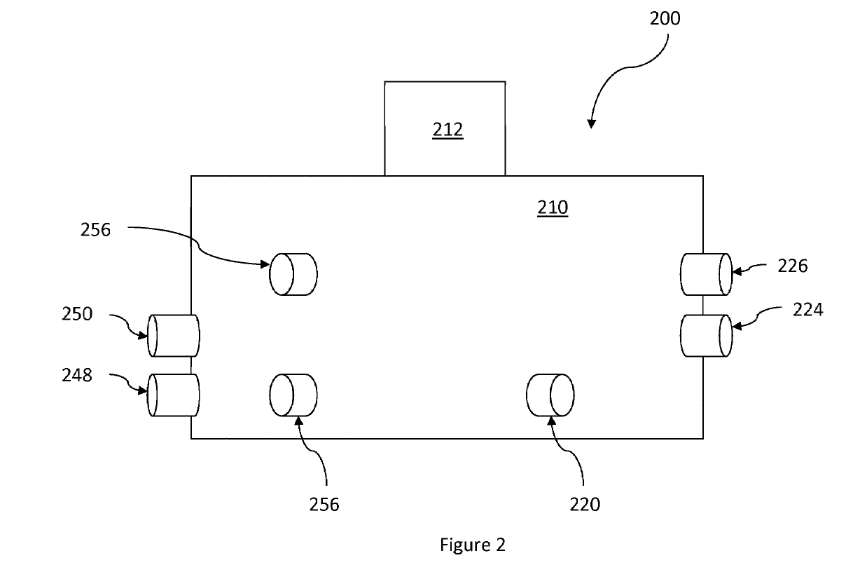

Referring to FIG. 2, the head 200 is shown. A shaft 212 permits rotation of the head 200 by a motor, not shown. A body 210 is aligned coaxial with shaft 212 and is preferably cylindrical in shape, however, it may be any shape, such as octagonal, that will permit axial orientation of the pins. About the periphery of body 210 are a combination of pins 220, 224, 226, 248, 250, 254 and 256.

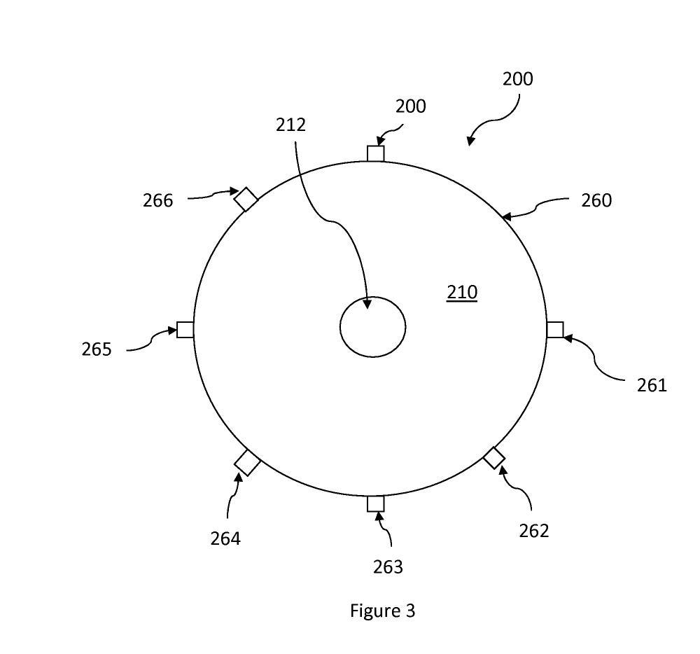

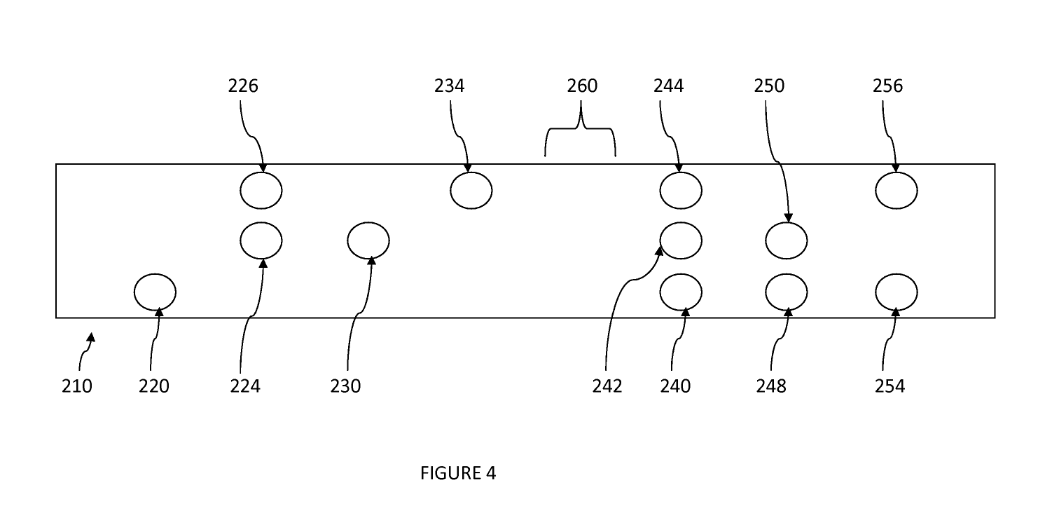

FIG. 3 is a top view of head 200. Shaft 212 being smaller then body 210. Body 210 is in axial alignment with shaft 212. The body 210 has a number of pin locations about the periphery equal to 2ⁿ−1 where n equals the number of pins or the number of dots in the Braille cell or a single column of the Braille cell. One of the possible combinations is where no pins are raised thus one location can be subtracted. Thus where a single column of a standard Braille cell is printed, there are 2³−1 or 7 required locations about the periphery each having up to three pins. For an expanded Braille cell the head would contain 2⁴−1 or 15 locations about the periphery which may contain up to four pins each. For printing a full Braille cell the print head could contain 2⁶−1 equal to 63 or 2⁸−1 equal to 127 locations on the print head. An additional location 260 may have no pins to provide for a blank set of dots or a column having no raised dots. Additionally, location 260 may contain a flat raised portion extending from the top to bottom of body 210. This feature can be useful for deleting raised dots by pressing the paper between it and an opposing flat surface on the anvil. The other locations contain at least one pin and represent the reaming potential combinations of the three pin locations. Three locations have a single pin represented by 264 and 265 and 267. Three locations have two pins represented by 262, 263 and 266. One location has three pins represented by 261. The pin for a single column standard Braille cell locations are further shown in FIG. 4.

FIG. 4 shows the periphery of the body 210 as if it were unrolled and laid on a flat surface. Pins 220, 224, 226, 230, 234, 240, 242, 244, 248, 250, 254, 256 represent each of the potential combinations of pins for each of the two columns of a Braille cell. Location 260 represents no raised pins. While, a particular pin or set of pins may be shown in relation to other pin combinations, the pin combinations may be arranged in any manner. Thus, all single pin combinations may be located next to each other as well as all two pin combinations next to each other.

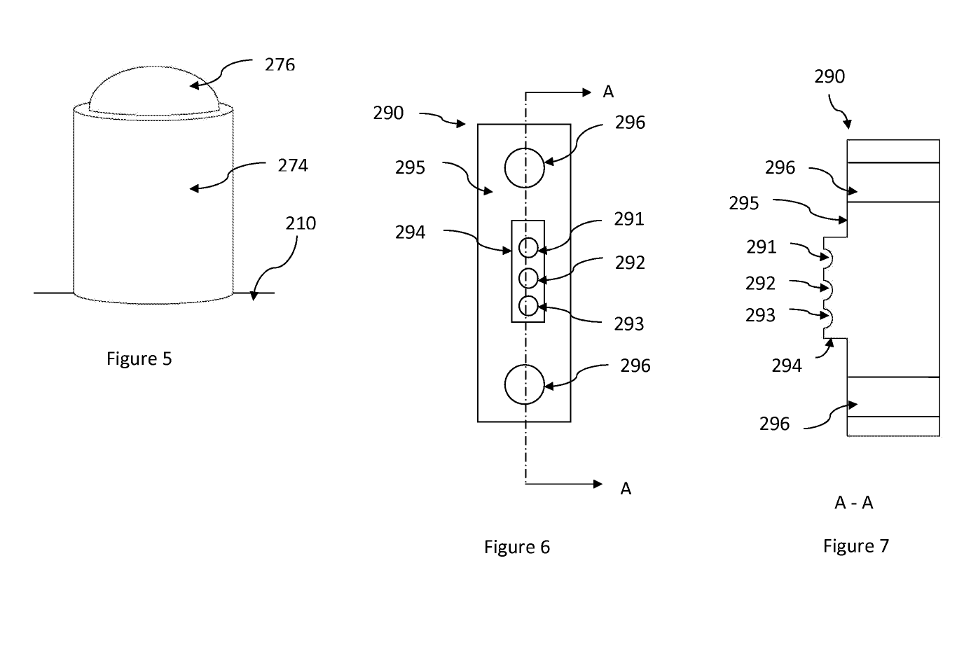

FIG. 5 indicates the shape of a pin. Body 274 may be any height or shape capable of offsetting hammer 276 from the head 200. Hammer 276 contacts the paper, forcing the paper to form to the inside of a divot in the anvil, during forming of a raised dot. Hammer 276 is formed slightly smaller than the standard size for a raised Braille dot because the actual raised dot is formed by the inside dimensions of the related divot in the anvil.

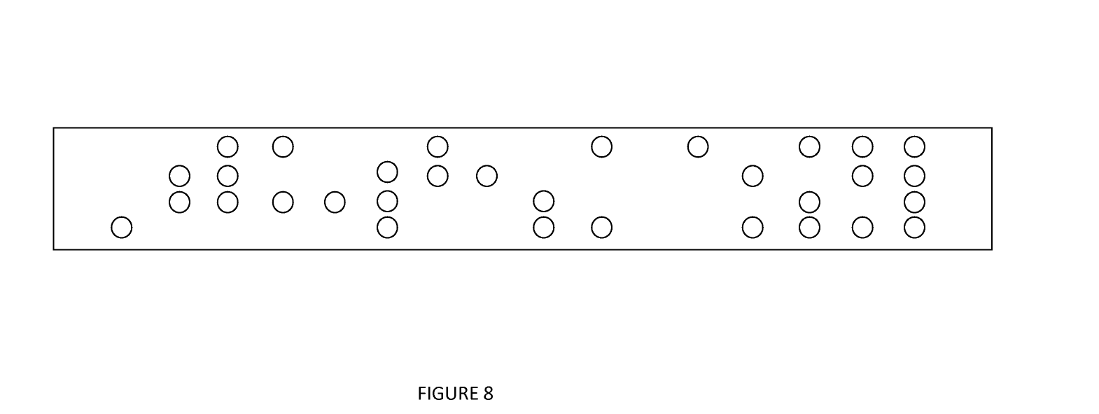

The anvil 290 as shown in FIG. 6 has three divots 291, 292, 293 formed in the top of a seat 294. Seat 294 sets the divots above the lower body 295 of the anvil 290. The body 295 may have holes 296 to secure to a cam or solenoid for moving into contact with the paper during embossing of the Braille characters. The divots are aligned with the pins on the body 210 of print head 200. The divots 291, 292, 293 form the top of a raised dot. As shown in FIG. 7 divots 291, 292, 293 are semi-circular in depth and are formed only a short distance into the step 294. Divots 291, 292, 293 are defined geometrically by the International Braille Standards which are incorporated by reference.

Where an expanded Braille cell printing mechanism is used the body 210 has 16 locations or sides. A sample of the pin layout is shown in FIG. 8. As the standard pin locations for standard and expanded Braille cells are well known, a sample is not provided, however, based on the forgoing description it is understood how to create a Braille head of the invention with a complete Braille cell set.

While the above description is illustrated in terms of specific embodiments, the drawings and examples are not intended to be limiting. Further even though only certain preferred features of the invention have been illustrated and described, many modifications and changes will occur to those skilled in the art. It is, therefore, to be understood that the appended claims are intended to cover all the true spirit of the invention.

I claim:

1. A print head for a Braille printer for embossing a substrate, comprising: an anvil and a head, the head being generally cylindrical in shape and further comprising;
a peripheral portion;
a number of locations about the peripheral portion;
each of said locations having at least one position, each of said positions contains either a pin or no pin.

2. The print head for a Braille printer of claim 1, wherein the peripheral portion comprises 7 locations each location having three positions in a single column, each of said positions contains either a pin or no pin.

3. The print head for a Braille printer of claim 1, wherein the peripheral portion comprises 15 locations each location having four positions in a single column, each of said positions contains either a pin or no pin.

4. The print head for a Braille printer of claim 1, wherein the peripheral portion comprises 63 locations each location having four positions in each of two columns, each of said positions contains either a pin or no pin.

5. The print head for a Braille printer of claim 1, wherein the peripheral portion comprises 127 locations each location having four positions in each of two columns each of said positions contains either a pin or no pin.

6. The print head for a Braille printer of claim 2, further comprising a location having no pins.

7. The print head for a Braille printer of claim 3, further comprising a location having no pins.

8. The print head for a Braille printer of claim 4, further comprising a location having no pins.

9. The print head for a Braille printer of claim 5, further comprising a location having no pins.

10. The print head for a Braille printer of claim 2, further comprising a location having a raised flat area configured to de-emboss a substrate.

11. The print head for a Braille printer of claim 3, further comprising a location having a raised flat area configured to de-emboss a substrate.

12. The print head for a Braille printer of claim 4, further comprising a location having a raised flat area configured to de-emboss a substrate.

13. The print head for a Braille printer of claim 5, further comprising a location having a raised flat area configured to de-emboss a substrate.
